(19) United States
(12) Patent Application Publication
(10) Pub. No.: US 2009/0013012 A1
(43) Pub. Date: Jan. 8, 2009

(54) JOURNAL MANAGEMENT METHOD IN CDP REMOTE CONFIGURATION

(75) Inventors: Naoko ICHIKAWA, Yokohama (JP); Wataru OKADA, Yokohama (JP); Yuichi TAGUCHI, Sagamihara (JP); Masayuki Yamamoto, Sagamihara (JP)

Correspondence Address: SUGHRUE MION, PLLC, 2100 PENNSYLVANIA AVENUE, N.W., SUITE 800, WASHINGTON, DC, 20037, US

(73) Assignee: Hitachi, Ltd., Tokyo (JP)

(21) Appl. No.: 11/968,383

(22) Filed: Jan. 2, 2008

(30) Foreign Application Priority Data
Jul. 3, 2007 (JP) 2007-174717

(51) Int. Cl. G06F 12/00

(52) U.S. Cl. 707/204

(57) ABSTRACT

A first storage system specifies a journal to be transferred in accordance with a time period for retaining write data in update (write) units of data in a second storage system, and transfers this journal to the second storage system. Data for which the retention period has expired is transferred by selecting write data by address.

### CROSS-REFERENCE TO RELATED APPLICATIONS

This application relates to and claims priority from Japanese Patent Application No. 2007-174717 filed on Jul. 3, 2007, the entire disclosure of which is incorporated herein by reference.

### BACKGROUND

The technology disclosed in the present invention generally relates to a computer system having a computer and storage apparatuses, and more particularly to data copy control between storage apparatuses.

There is technology for storing a data update history, and restoring data of an arbitrary time in data update (write) units. Japanese Patent Laid-open No. 2005-222110 discloses technology for restoring data of an arbitrary point in time in a restorable range in either a first storage apparatus or a second storage apparatus by transferring data update history information (hereinafter, a journal) and control information from a first storage apparatus to a second storage apparatus installed in a remote location. Further, US Unexamined Patent Application Publication No. US20050028022A1 discloses technology for compressing journal data and reducing the volume of the amount of data transferred by updating write data to the same address by overwriting the most recent journal during the above-mentioned journal transfer.

When applying technology, which makes it possible to restore data of an arbitrary point in time in the first and second storage apparatuses, it is desirable that, even if a data transfer between storage apparatuses is suspended for a fixed time, the data of an arbitrary point in time be capable of being transferred subsequent to resuming data transfer the same as prior to the data transfer being cancelled.

In Japanese Patent Laid-open No. 2005-222110, when a journal transfer process is suspended for a fixed period of time due to a failure or a planned suspend, the journals are stored in the first storage apparatus until transfer resumes, and transfer to the second storage apparatus is complete. Then, when the transfer of journals resumes, transferring all of the journals, which were stored in the first storage apparatus during the period that the journal transfer was suspended, can increase journal transfer volume by the length of the suspend period, lengthen the time required for transfer, and delay the resumption of operations in the second storage apparatus. Conversely, when journal data is compressed to shorten the time required to transfer the journals as in US Unexamined Patent Application Publication No. US20050028022A1, update history information for a write to the same address can be lost, and the condition for recovering work requested by the second storage apparatus cannot be met without restoring data of an arbitrary point in time in data update (write) units.

### SUMMARY

To solve for the above-mentioned problems, in one aspect of the present invention, a first storage system specifies journals to be transferred and transfers same to a second storage system in accordance with a write data retention period in data update (write) units of the second storage system. When there are a plurality of data for a single address, among the data for which the retention period has expired, a selected data from among the plurality of data is transferred.

### BRIEF DESCRIPTION OF THE DRAWINGS

FIG. 1 is a diagram showing the configuration of a computer system in a first embodiment of the present invention;

FIG. 2 is a diagram schematically showing the configuration inside a storage apparatus in the first embodiment of the present invention;

FIG. 3 is a diagram schematically showing the journal transfer range when data copy resumes in this embodiment;

FIG. 4 is a diagram schematically showing the data recovery method at an arbitrary point in time in this embodiment;

FIG. 5 is an example of a pair configuration management table stored in a storage apparatus;

FIG. 6 is an example of a copy status management table stored in a storage apparatus;

FIG. 7 is an example of a journal information management table stored in a storage apparatus;

FIG. 8 is an example of a snapshot management table stored in a storage apparatus;

FIG. 9 is a diagram schematically showing the configuration inside a management computer in the first embodiment of the present invention;

FIG. 10 is an example of a journal valid period management table stored in the management computer;

FIG. 11 is a status transition diagram denoting the flow of operations in a computer system of this embodiment;

FIG. 12 is a diagram showing a copy suspend process flow in this embodiment;

FIG. 13 shows the flow of journal management when the copy status is “suspend” in this embodiment;

FIG. 14 is a diagram showing the process flow at copy resume in this embodiment;

FIG. 15 is a diagram showing the flow of a data recovery process in this embodiment;

FIG. 16 is an example of an output screen in this embodiment;

FIG. 17 is a diagram schematically showing the configuration inside the management computer in a modification;

FIG. 18 is an example of a transfer journal management table stored in the management computer in the modification;

FIG. 19 is a diagram showing the process flow of a journal monitoring program executed by the management computer in the modification;

FIG. 20 is an example showing the process flow at copy resume in the modification; and

FIG. 21 denotes the copy suspend process flow in accordance with a management operation in this embodiment.

### DETAILED DESCRIPTION OF THE PREFERRED EMBODIMENT

The embodiments of the present invention will be explained below while referring to the figures.

### First Embodiment

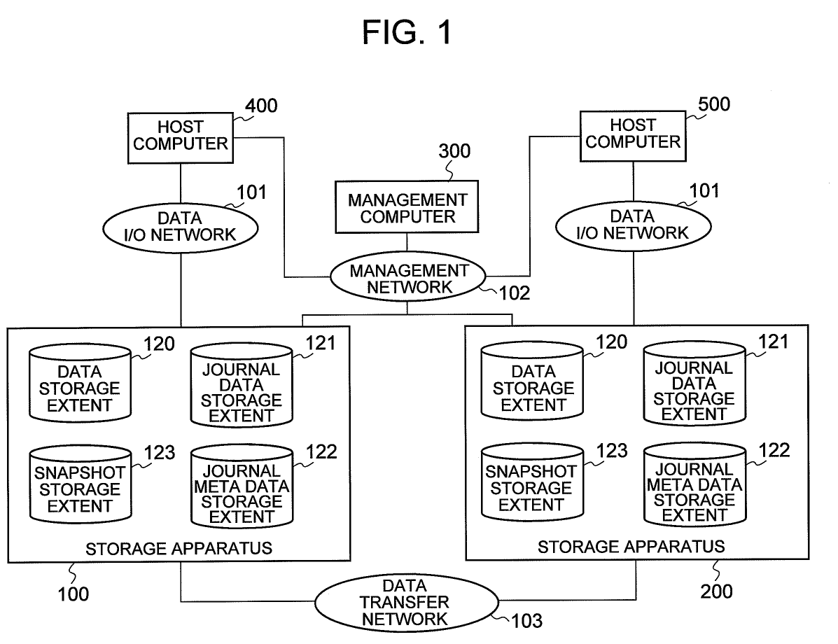

A first embodiment of the present invention will be explained below using FIGS. 1 through 18. FIG. 1 is a diagram schematically showing the configuration of the first embodiment.

In FIG. 1, a host computer 400 and a storage apparatus (storage system) 100 are connected via a data I/O network 101. Further, the storage apparatus 100 and a storage apparatus (storage system) 200 are connected and communicate with one another via a data transfer network 103. The data I/O network 101 and the data transfer network 103 comprise an ordinary network connection mode, such as a fibre channel or IP network.

Further, this embodiment has a management computer 300, which carries out management related to data communications between storage apparatus 100 and storage apparatus 200, and configurations for the allocation and cancellation of a storage extent. The management computer 300 is connected to storage apparatus 100 and storage apparatus 200 via a management network 102. The management network 102 is constituted by an ordinary network connector, such as an IP network. Further, this management network 102 can be a mode, in which the above-mentioned data I/O network 101 and data transfer network 103 share the same network. The management computer 300, storage apparatus 100 and storage apparatus 200 exchange management information with one another via this management network 102. Further, the management computer 300 is connected to computers 400 and 500 via the management network 102, and carries out the exchange of information required to use storage apparatus 100.

Storage apparatus 100 has a data storage extent 120 (a storage extent can also be referred to as volume), journal data storage extent 121, journal meta data storage extent 122, and snapshot storage extent 123 as storage extents. The data storage extent 120, upon receipt of a write request from the host computer 400, is updated using data contained in a write request for a specified address, and thereafter is used by the computer. Further, the journal data storage extent 121 stores update data (hereinafter, journal data) for the data storage extent 120, which is acquired by a journal acquisition program 133 described hereinbelow. The journal meta data storage extent 122 stores update history information (journal meta data) for the data storage extent 120. However, depending on the storage apparatus, the journal data storage extent 121 and journal meta data storage extent 122 can be the same storage extent.

Furthermore, the snapshot storage extent 123 stores a snapshot, which is prepared by a snapshot acquisition program, which will be described hereinbelow. A “snapshot” signifies either a whole or partial data image of either one or a plurality of storage extents 120 at a certain specified point in time.

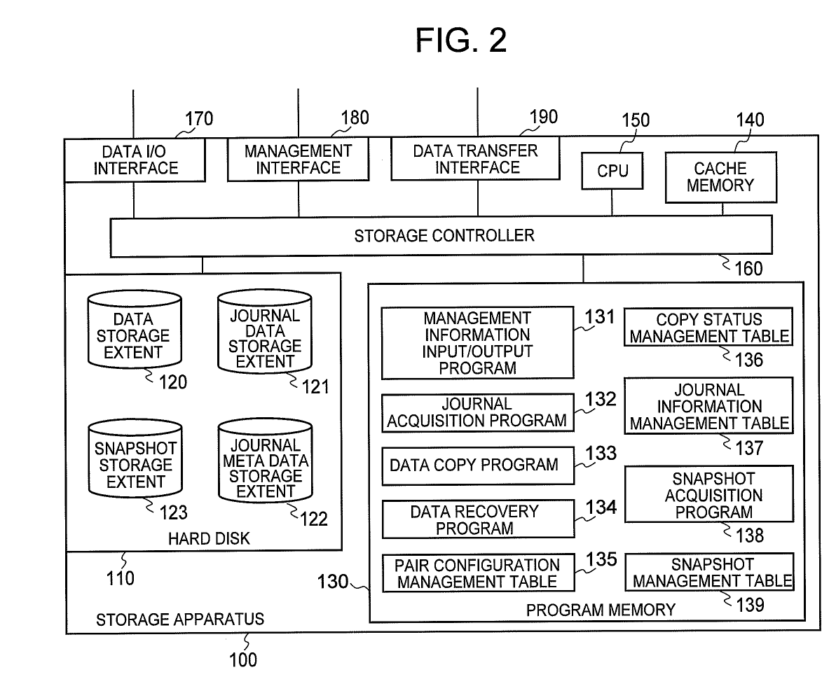

FIG. 2 shows the hardware configuration of storage apparatus 100. Storage apparatus 100 has a storage controller 160, hard disk 110, program memory 130, cache memory 140 and CPU 150. To carry out communications outside the storage apparatus, storage apparatus 100 also has a data I/O interface 170, management interface 180, and data transfer interface 190, which are connected to the storage controller 160 according to the application.

The cache memory 140 physically can be an ordinary semiconductor storage device, and is used as a temporary data storage extent, the same as that of a general-purpose computer.

The hard disk 110, for example, is one or more magnetic disk devices, that is, a storage device generally called a hard disk, logically constitutes a plurality of storage extents, and constitutes any one or more of the data storage extent 120, the journal data storage extent 121, the journal meta data storage extent 122, and snapshot storage extent 123.

The program memory 130 is a storage extent physically constituted by a magnetic disk device or semiconductor storage device. The program memory 130 holds various program groups and information responsible for the operation of the storage apparatus, and either a control unit or CPU executes the various programs by reading in the various program groups or information. The program memory 130 stores a management information input/output program 131, journal acquisition program 132, data copy program 133, data recovery program 134, pair configuration management program 135, copy status management table 136, journal information management table 137, snapshot acquisition program 138, and snapshot management table 139.

The management information input/output program 131 carries out the exchange of management information between storage apparatus 100, management computer 300 and storage apparatus 200. Further, the management information input/output program 131 also transmits received management information to either a program or table inside the program memory 130. For example, when a resume data copy request is issued from the management computer 300, the management information input/output program 131 receives this information and transmits same to the data copy program 132.

The journal acquisition program 132 collects journal data and journal meta data for all write operations transmitted to the data storage extent 120 from the host computer 400. Journal meta data comprises at least the time at which journal data was written, address information of the write-target data storage extent, an address inside the write-target data storage extent (write start location) and write order number. The write order number is the number, which the journal acquisition program 132 assigns to the order in which data is written. The journal acquisition program 132 respectively stores collected journal data and journal meta data in the journal data storage extent 121 and journal meta data storage extent 122. Furthermore, in this specification, journal data and journal meta data can be combined and simply referred to as “journals”.

The data copy program 133 transfers journal data and journal meta data asynchronously with a data write process to the data storage extent 120 to storage apparatus 200, which has a data storage extent 120 defined as a pair (combined to constitute a pair) in the pair configuration management table 135, which will be described below. Further, the data copy program 133 updates as needed the copy status management table 136, which stores information related to the status of a data copy process. For example, when a data copy process ends abnormally due to a failure of the data transfer network, the data copy program 133 cancels copy processing, and updates to “suspend” the copy status information managed by the copy status management table 136 for the pertinent pair. Details concerning the copy status management table 136 will be explained hereinbelow. However, the data copy program 133 can re-execute (retry) copy processing during a fixed period from the occurrence of a failure until the updating of the copy status information.

Further, when resuming a data copy process from the “suspend” copy status, the data copy program 133 selects a journal for transfer to the storage apparatus 200 based on information related to a journal valid period acquired from the management computer 300. The journal valid period is information related to a journal retention period, which is managed by the management computer 300, and which is associated with the respective data storage extents.

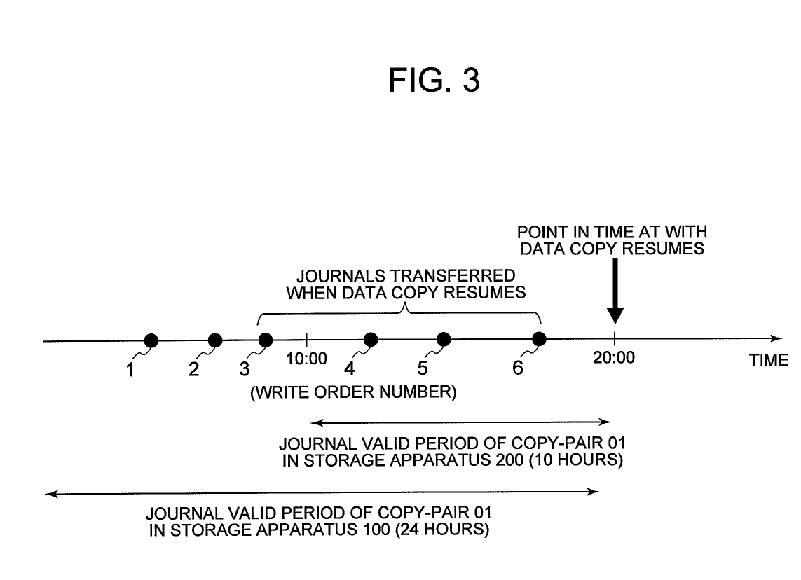

FIG. 3 shows a method of selecting a journal to be transferred to the storage apparatus 200 when resuming a data copy process. FIG. 3 schematically denotes the relationship between journals acquired for a data write process at an address inside a certain data storage extent 120 and journals to be transferred when data copy resumes, and the relationship with the journal valid period at respective times on a time axis. The black dots arranged on the time axis signify journals acquired at respective times, and the numerals assigned to the black dots are the write order numbers assigned to the respective journal meta data. Then, the arrows show that the journal valid period of the storage extent associated to the copy pair 01 of storage apparatus 100 is 24 hours, and that the journal valid period of the storage extent associated to the copy pair 01 of storage apparatus 200 is 10 hours.

As shown in the example of FIG. 3, when the journal valid period in storage apparatus 200 is 10 hours, and a data copy from storage apparatus 100 to storage apparatus 200 will resume at the time 20:00, all journals acquired at and after the time 10:00, which is 10 hours prior, that is, the journals denoted by write order numbers 4, 5, 6, and the most recent journal of the journals acquired prior to the time 10:00, that is, the journal denoted by the write order number 3, are transferred to storage apparatus 200 in write order number sequence.

Meanwhile, the storage apparatus 200, which constitutes the data copy target, has the same data copy program 133 and copy configuration management table, which will be explained below, as the storage apparatus 100. The data copy program 133 in storage apparatus 200 respectively stores journal data and journal meta data received from storage apparatus 100 in the journal data storage extent 121 and journal meta data storage extent 122 of its own apparatus. Further, the data copy program 133 implements write processing in the pertinent data storage extent 120 in the write order number sequence assigned to the journal meta data.

The snapshot acquisition program 138 acquires a snapshot of the data storage extent 120 at a specified point in time. In this specification, a “snapshot” signifies either a whole or partial data image of either one or a plurality of data storage extents at a specified point in time. An acquired snapshot is stored in the snapshot storage extent 123.

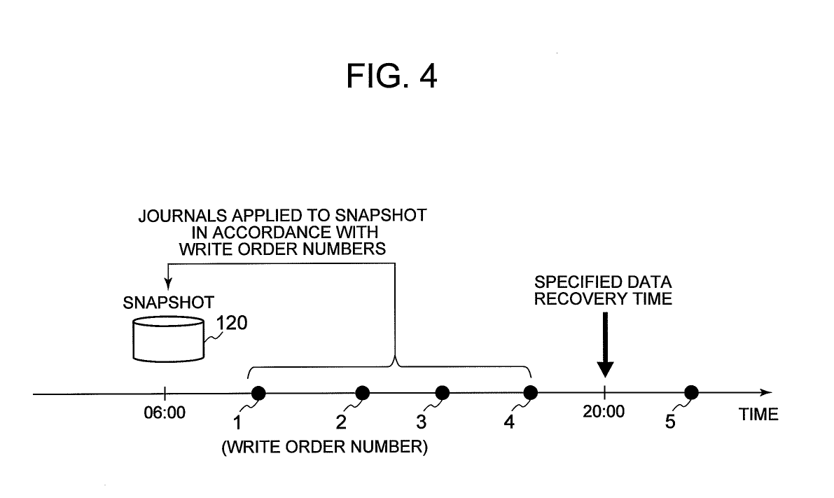

The data recovery program 134 recovers data at a specified data recovery time received from the management computer 300. The data recovery method executed by the data recovery program 134 will be explained using FIG. 4. Furthermore, the data recovery technique explained in this section is disclosed in Japanese Patent Laid-open No. 2005-222110.

FIG. 4 schematically denotes the relationship between a snapshot of a storage extent 120 at a past point in time, and journals acquired at respective times on a time axis. The black dots arranged on the time axis signify journals acquired at respective times, and the numerals assigned to the black dots are the write order numbers assigned to the respective journal meta data.

The data recovery program 134, upon receiving a specified data recovery time (for example, a time of 20:00) from the management computer 300, applies journal data acquired between 06:00, the time which the snapshot denotes, and 20:00, the data recovery target time, to the snapshot data in the write order number sequence allocated to the journal meta data.

For example, in FIG. 4, the journals acquired between 06:00 and 20:00 are the journals, which have been assigned the write order numbers 1, 2, 3, 4, and the journal assigned the write order number of 5 falls outside the target range. Therefore, the data recovery program 134 can recover data at the specified data recovery time by applying these journals to the snapshot in order.

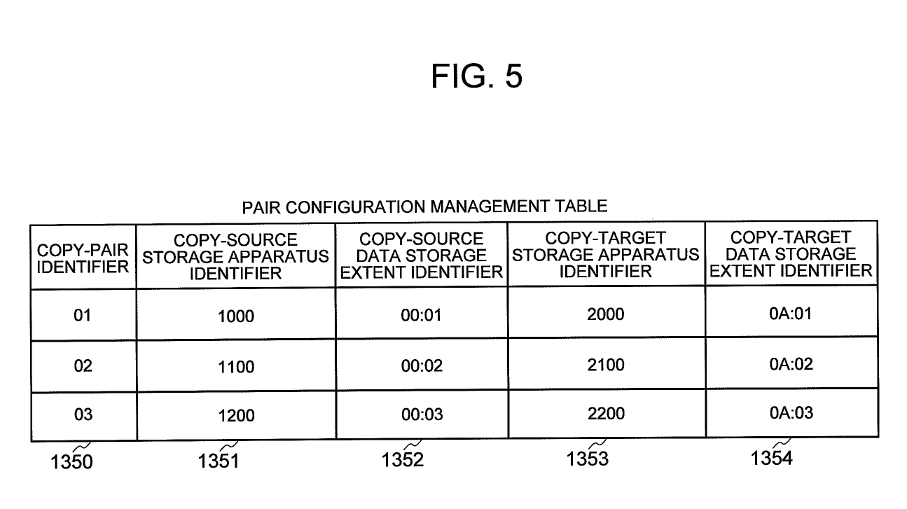

The pair configuration management table 135 defines the configuration of a pair (combination constituting a pair) of data storage extents inside storage apparatus 100 and storage apparatus 200 when the data copy program 133 implements data copy processing. Pair configuration signifies the correspondence between the data storage extents 120, which will become the copy-source and copy-target in a data copy process by the data copy program. An example of a pair information management table 135 is shown in FIG. 5. In FIG. 5, the pair information management table 135 has columns for a copy-pair identifier 1350, copy-source storage apparatus identifier 1351, copy-source data storage extent identifier 1352, copy-target storage apparatus identifier 1353, and copy-target storage extent identifier 1354.

The copy-pair identifier 1350 is an identifier for specifying a copy-pair. The copy-source data storage extent identifier 1352 and copy-source storage apparatus identifier 1351 are the identifier for specifying the data storage extent of the copy-source and the identifier for specifying the storage apparatus, which has the copy-source data storage extent, from among the data storage extents constituting a copy-pair specified by the copy-pair identifier 1350. The copy-target data storage extent identifier 1354 and copy-target storage apparatus identifier 1353 are the identifier for specifying the data storage extent of the copy-target and the identifier for specifying the storage apparatus having the copy-target data storage extent, which are configured by the copy-pair identifier 1350.

For example, the copy-pair denoted by copy-pair identifier 01 is the relationship via which write data for the data storage extent specified by data storage extent identifier 00:01 inside the storage apparatus specified by storage apparatus identifier 1000 is to be copied by data copy program 133 to the data storage extent specified by data storage extent identifier 0A:01 of the storage apparatus specified by storage apparatus identifier 2000.

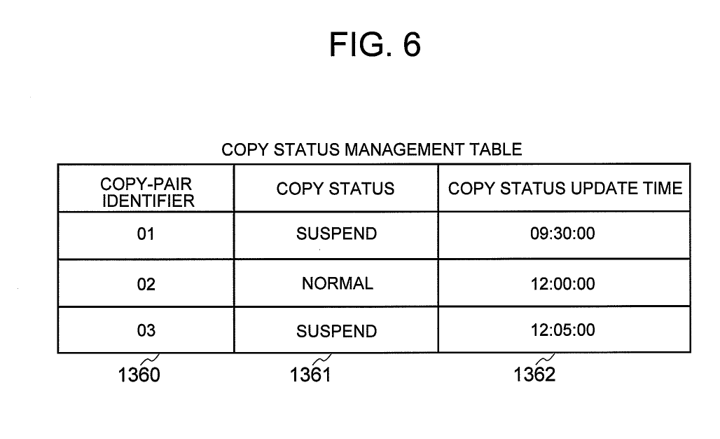

The copy status management table 136 stores management information related to the statuses of data copy processes by copy-pairs in accordance with the data copy program 133. An example of a copy status management table 136 is shown in FIG. 6. The copy status management table 136 at the least holds information such as a copy-pair identifier 1360, copy processing status 1361, and copy status update time 1362. The copy processing status 1361 shows the copy status between data storage extents constituting a copy-pair specified by the copy-pair identifier 1360. When the copy processing status is “Normal”, it is a state in which a communication failure has not been detected between the copy-pair, and shows that it is a state in which a journal can be transferred. When the copy processing status is “Suspend”, it is a state in which a journal cannot be transferred due to a communication failure or system management operation, and shows a state in which journals, which are not capable of being transferred to the journal data storage extent of storage apparatus 100, are stored. The copy status update time shows the time at which the copy status of a copy-pair was updated.

For example, FIG. 6 denotes that the copy-pair of identifier 01 was updated to “Suspend” at the time 09:30:00.

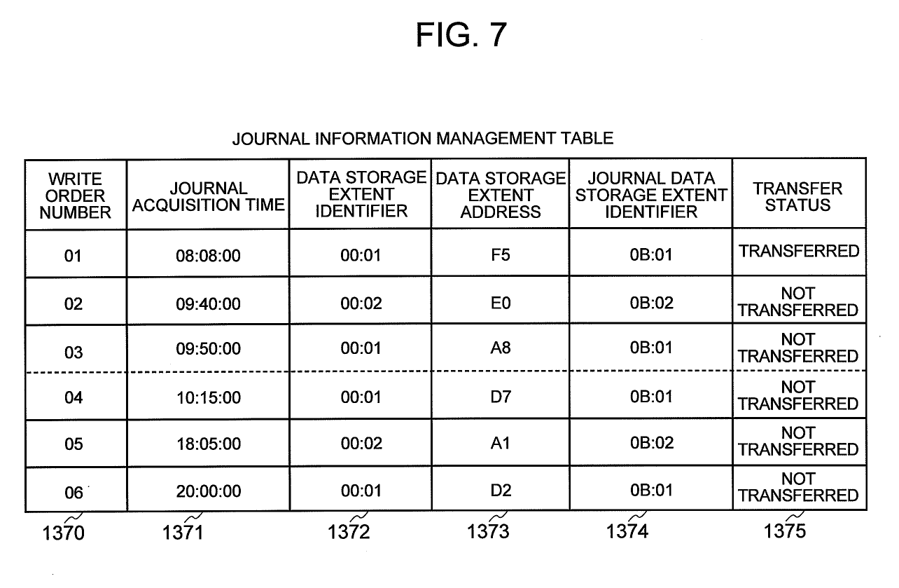

FIG. 7 is an example of a journal information management table 137. The journal information management table 137 holds management information related to journals acquired by the journal acquisition program 132. The journal management information table 137 at the least has a write order number 1370, journal acquisition time 1371, data storage extent identifier 1372, data storage extent data start location 1373, journal data storage extent identifier 1374, and an area for storing information related to the transfer status 1375.

The write order number 1370 denotes the write order for a data storage extent of journals retained in the journal data storage extent, and denotes the data contained in the respective journal data written to a data storage extent in accordance with this order. The journal acquisition time 1371 denotes the time at which a write is generated to a data storage extent, and the journals of this write data are acquired. The data storage extent identifier 1372 denotes identification information of the data storage extent to which the write is generated, and the journal acquisition program 132 records the write to this data storage extent as a journal.

The data storage extent address 1373 denotes location information inside the write-generated data storage extent, which corresponds to this journal. The journal storage extent identifier 1374 denotes identification information of the journal data storage extent in which this journal data is recorded. The transfer status 1375 is information denoting whether or not this journal data has been transferred from the copy-source storage apparatus to the copy-target storage apparatus, and when this data has been transferred, depicts the character string for “Transferred”, and when this data has not been transferred, depicts the character string for “Not Transferred”. The transfer status 1375 also depicts the character string “Transfer Unnecessary” showing that transfer is not required. In this embodiment, the transfer status was depicted as a character string, but this status can also be depicted as a truth-value, such as either a “0” or a “1”.

For example, FIG. 7 denotes that the journal, for which the write order number is denoted as 01, is the journal for data, which was acquired at the time 08:08:00, and which is written to the location of address F5 inside the data storage extent denoted by identifier 00:01, that the journal data, which is update data, is stored in storage extent 0B:01, and that the journal has already been transferred to storage apparatus 200 by the data copy program 133.

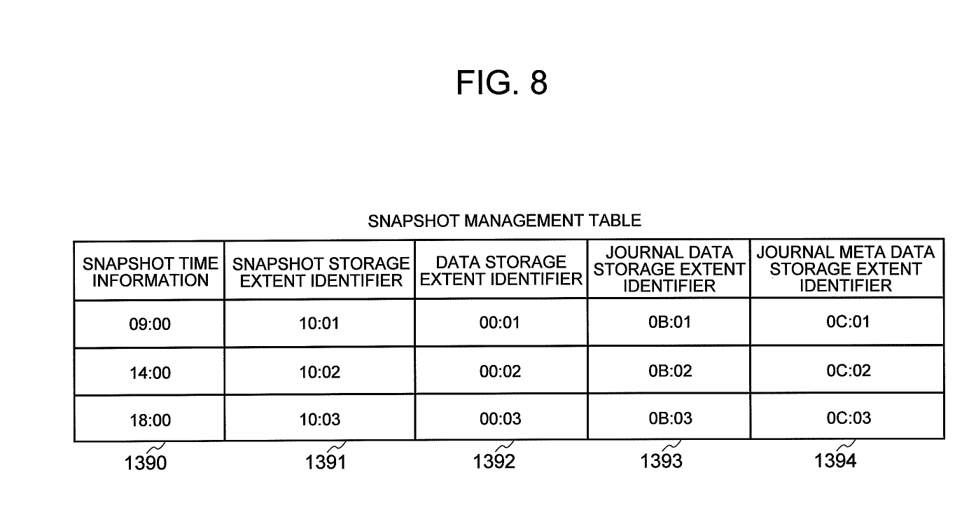

FIG. 8 shows an example of a snapshot management table. The snapshot management table 139 manages information related to a snapshot of the data storage extent 120 held by storage apparatus 100. The snapshot management table 139 is constituted by time information (field 1390) denoting the time at which the snapshot was acquired in the table's own storage apparatus, a snapshot storage extent identifier (field 1391), which is the storage location of the acquired snapshot, an identifier of the data storage extent (field 1392) equivalent to the original data from which the snapshot was prepared, an identifier of the journal data storage extent (field 1393) in which journal data of the write to this data storage extent is stored, and an identifier of the journal meta data storage extent (field 1394) in which the journal meta data of the write to this data storage extent is stored.

For example, in FIG. 8, a snapshot equivalent to time information 09:00 is stored in the snapshot storage extent denoted as 10:01. Further, this snapshot was prepared for data storage extent 00:01, and the journal data and journal meta data related thereto are stored in storage extents respectively denoted by identifiers 0B:01 and 0C:01.

The configuration of storage apparatus 200 can be the same as that of storage apparatus 100. Further, in the program memory 130 inside storage apparatus 200, the journal acquisition program 132 and copy status management table 136 are not always necessary. However, according to the operation, storage apparatus 100 and storage apparatus 200 can carry out a data transfer in the opposite direction in accordance with the same procedure, and the above-mentioned program should be provided in this case.

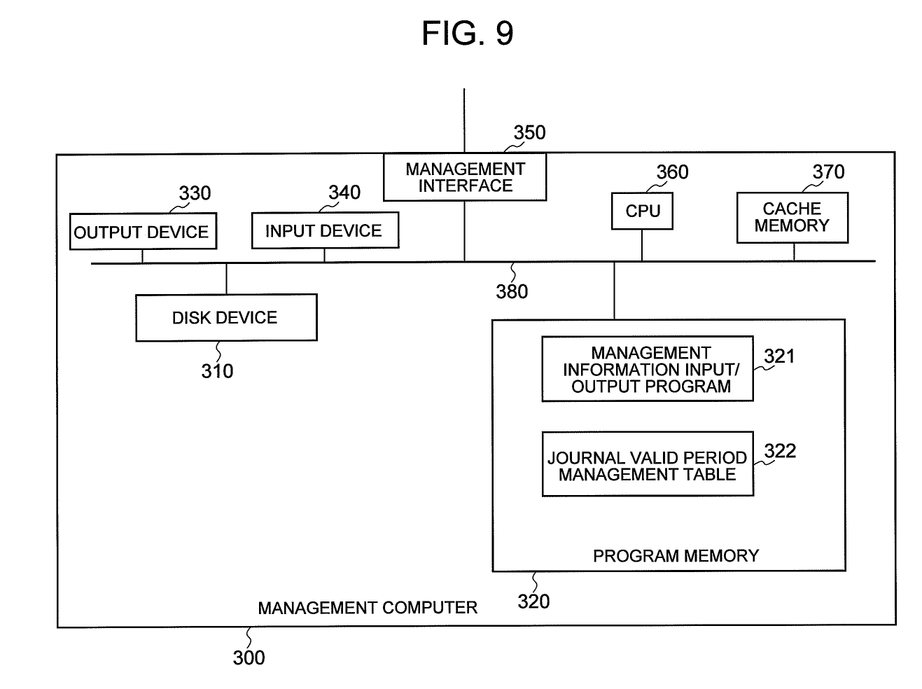

FIG. 9 shows the configuration of the management computer 300. The management computer 300 has a program memory 320, an output device 330, an input device 340, a management interface 350, a CPU 360, and a cache memory 370, and these are connected by a bus. The hardware configuration of the management computer 300, for example, can be the same as that of a general-purpose computer (PC). For example, the input device 350 can be a device such as a keyboard or mouse, and the output device 330 can be a display device such as a CRT or LCD, and a video output device. Similarly, the management interface 360 can be a general-purpose communication device, such as Ethernet (registered trademark). Program memory 320 can be a data storage device in accordance with either a magnetic storage device or a semiconductor storage device. Program memory 320 stores at least a management information input/output program 321 and a journal valid period management table 322. A program stored in program memory 320 is read out and executed by the CPU 360. Further, the CPU 360 references the required table stored in program memory when executing the respective programs.

The management information input/output program 321 carries out the sending and receiving of management information between the management computer 300, storage apparatus 100 and storage apparatus 200. The management information input/output program 321 also transmits received management information to either the program or table inside the program memory 320. That is, the CPU 360 stores management information received by executing the management information input/output program 321 in program memory, and uses the management information to execute a different program.

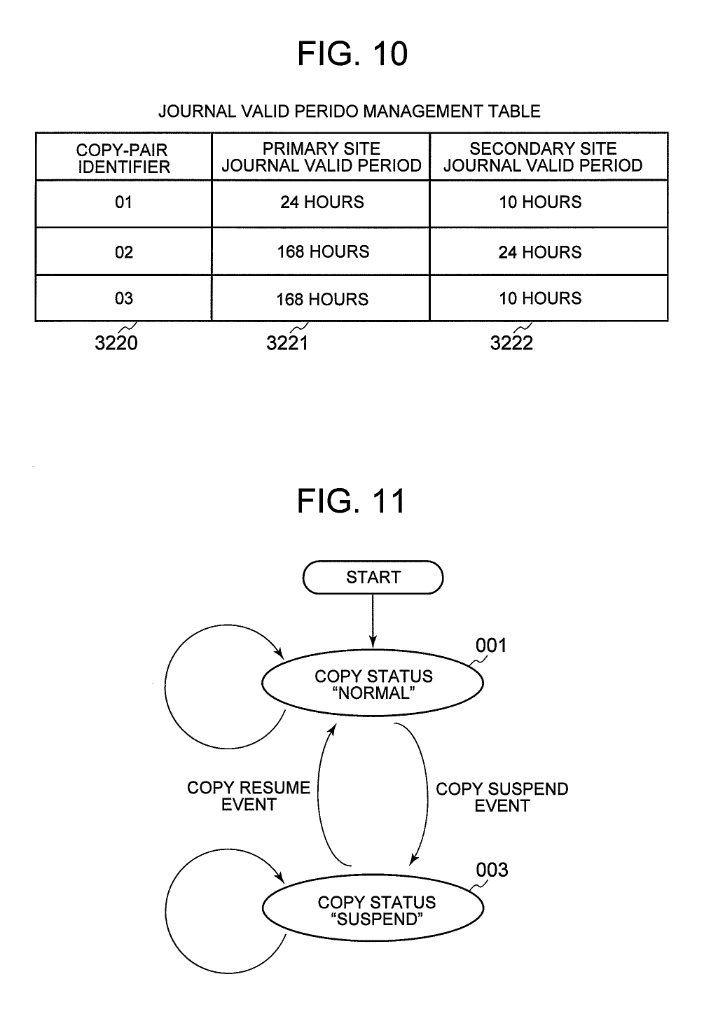

FIG. 10 shows an example of a journal valid period management table. The journal valid period management table 322 holds information related to the valid periods of journals stored in storage apparatus 100 and storage apparatus 200. The journal valid period management table 322 stores at least a copy-pair identifier (field 3220), a primary site journal valid period (field 3221) and a secondary site journal valid period (field 3222). The copy-pair identifier coincides with the pair configuration management table 135 inside storage apparatus 100. Further, the journal valid period signifies the period for retaining journals inside storage apparatus 100 and storage apparatus 200.

For example, for copy-pair identifier 01, the primary site journal valid period is 24 hours, and the secondary site journal valid period is 10 hours. That is, a journal for data updated up to 24 hours prior to the present time is stored in the primary site. Further, a journal for data updated up to 10 hours prior to the present time is stored in the secondary site.

A journal for which the journal valid period has elapsed, that is, using the above example, a journal, which was updated more than 24 hours prior to the present time, does not need to be stored in this storage system, and can be deleted. Or, deletion can be performed leaving only the most recent journal at each address inside the corresponding data storage extent 120. Or, journal data can be written to a past snapshot or a replication thereof, and a snapshot of a different point in time can be prepared and stored.

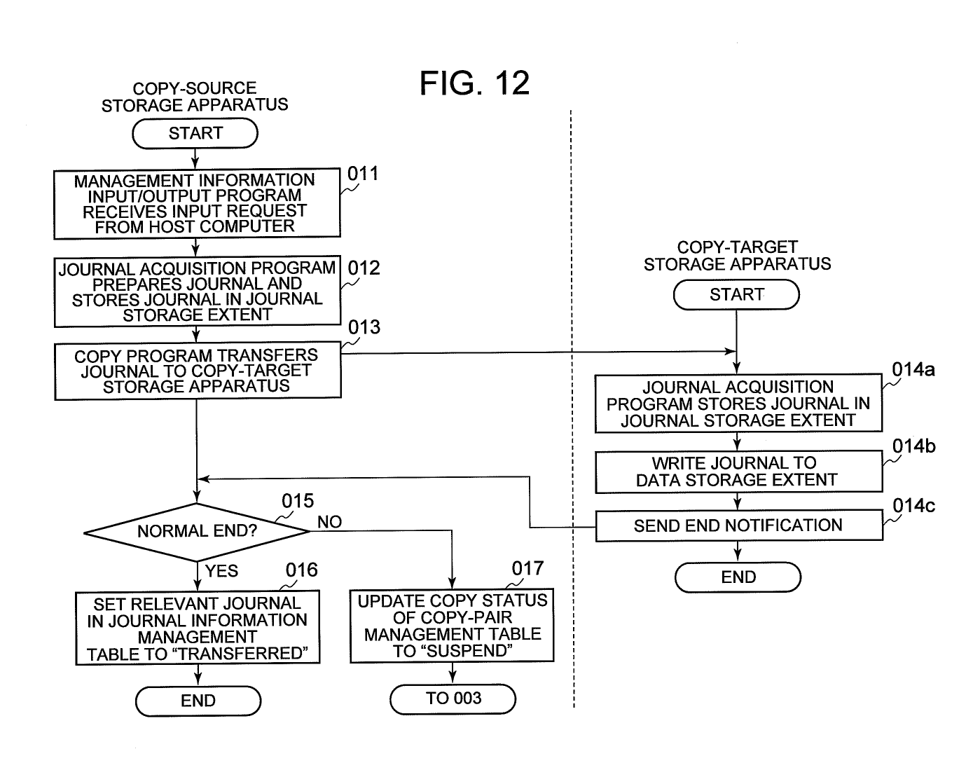

The processing in this embodiment will be explained using FIGS. 11, 12, 13, 14 and 15.

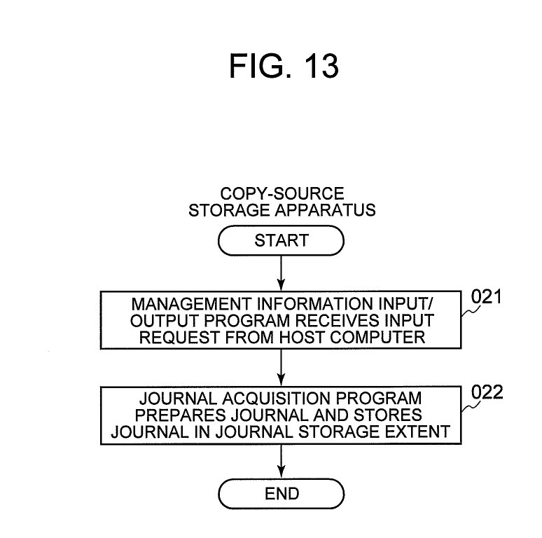

FIG. 11 is a status transition diagram denoting the flow of operations of a computer system of this embodiment. Ordinarily, the “copy status” of the copy status management table is “Normal”, and the pertinent computer system implements prescribed processing for “Normal”, which will be explained below using FIG. 12 (Step 001). If an event, which becomes a copy suspend factor, such as data transfer network failure or management operation, occurs when the copy status is normal, the “Copy Status” of the copy status management table transitions to “Suspend” (Step 003). In suspend status, the computer system implements prescribed processing for “Suspend”, which will be explained below using FIG. 13-A. When the copy status is suspend, the suspension factor is eliminated, and when a resume operation is carried out, the copy status transitions to “Normal” and the computer system implements the prescribed processing for “Normal”.

FIG. 12 shows the processing flow at “Normal”. The storage controller 160 inside storage apparatus 100 executes the management information input/output program 131, and a request to write to the data storage extent 120 is received from the host computer 400 (Step 011). Next, the storage controller executes the journal acquisition program 132, prepares journal data and journal meta data for this write data, and respectively stores same in the journal data storage extent 121 and the journal meta data storage extent 122 (Step 012).

Then, the storage controller 160 reads and executes the data copy program 133. First, the storage controller 160 references the copy status management table 136, and if the copy status is “Normal”, transfers the journal data and journal meta data via the data transfer interface 103 to storage apparatus 200, which has the storage extents 120 defined in the pair configuration management table 135 as being a pair (Step 013). In the meantime, the storage controller 160 processes the write data to the storage extents 120 asynchronously to the processing of the data copy program 133 the same as an ordinary write process (Step 013).

Further, the storage controller of storage apparatus 200, upon receiving the journal data and journal meta data, reads out the journal acquisition program, and respectively stores the received journal data and journal meta data in the journal data storage extent 121 and journal meta data storage extent 122 inside its own storage apparatus (Step 014a). Next, the storage controller of storage apparatus 200 implements a process for writing the journal data stored in the journal data storage extent in Step 014a to the data storage extent 120 in write order number sequence (Step 014b). Then, the storage apparatus 200 controller sends an end-notification message to storage apparatus 100 (Step 014c). If the execution results of Step 014a and Step 014b ended normally, the end-notification message comprises information to this extent, and if the execution results of Step 014a and Step 014b ended abnormally, the end-notification message comprises information to the effect that an error occurred, and an error number showing the type of error.

When data copy processing to storage apparatus 200 ends normally (Step 015: YES), the storage apparatus 100 storage controller 160, which executed the data copy program 133, updates the “Transfer Status” of the pertinent journals in the journal information management table 137 to “Transferred” (Step 016), and ends the processing for the pertinent write data.

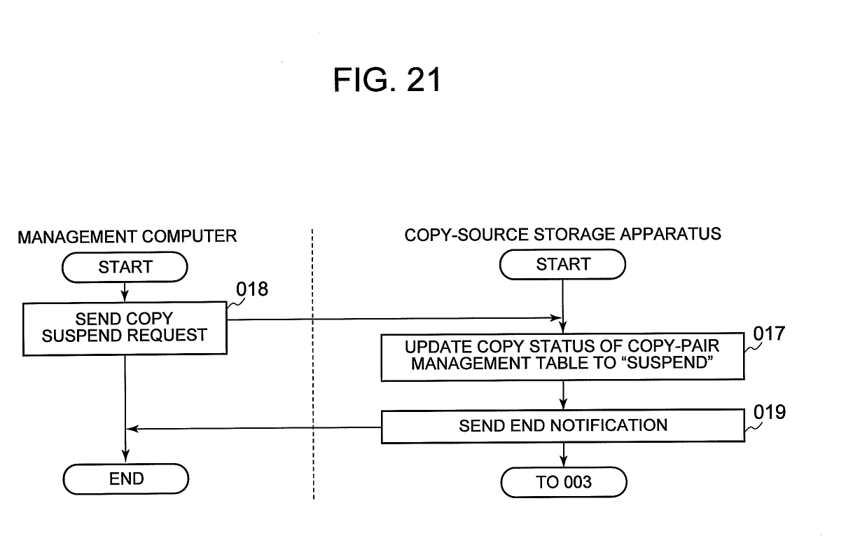

Further, when the data copy process resulted in an error (Step 015: NO), the storage apparatus 100 storage controller 160 updates the “Copy Status” of the pair configuration management table 136 to “Suspend” (Step 017). However, the storage controller 160 can re-execute (retry) copy processing during a fixed period until the “Copy Status” is updated. Further, when storage apparatus 200, which is the copy target, does not respond within a fixed period of time to the copy process, which storage apparatus 100 sent in Step 013, this is considered to be an abnormal end resulting from a communication failure, and a determination result of NO can be made in Step 015. Because the result of Step 017 causes the copy status to become “Suspend”, this system transitions to the status of Step 003 in FIG. 11.

Whereas FIG. 12 was a case which transitioned to the “Suspend” status based on the execution results of copy processing, FIG. 21 denotes the copy suspend processing flow in accordance with an management operation. The management computer 300 receives a copy suspend request input via an administrator input device operation. Upon receiving this input, the management computer 300 sends a copy suspend request message to storage apparatus 100 (Step 018). Storage apparatus 100 updates the copy status of the copy-pair management table to “Suspend” (Step 017), and sends an end-notification to the management computer 300 (Step 019). As a result of this, this system transitions to the status of Step 003 in FIG. 11.

FIG. 13 shows journal management when the copy status is “Suspend”. The process in which the storage controller 160 of storage apparatus 100 reads out and executes the management information input/output program 131 will be explained. The storage controller 160 receives a request from the host computer 400 to write to the data storage extent 120 (Step 021). The storage controller 160 executes the journal acquisition program 132, prepares journal meta data for this received write data and stores same in the journal meta data storage extent 121, and stores journal data in the journal data storage extent (Step 022). In the meantime, the storage controller 160 processes the data written to the storage extent 120 asynchronously to the process for executing the data copy program 133, the same as an ordinary write process.

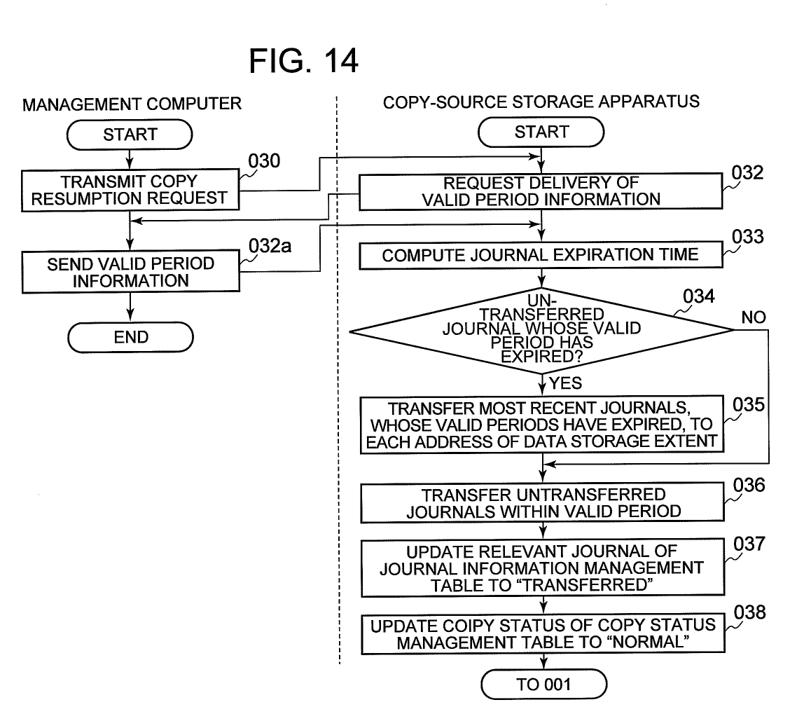

FIG. 14 shows the flow of processing when copying resumes, that is, the processing when the copy status returns to “Normal” from “Suspend” upon receiving input via an administrator operation.

First, the administrator transmits via the input device of the management computer 300 a resume copy request, which specifies one copy-pair or a plurality of copy-pairs, and the management computer 300 sends the resume copy request to storage apparatus 100 (Step 030). The storage controller 160 of storage apparatus 100 executes the data copy program 133, and requests the delivery of a journal valid period in the storage apparatus 200 side of the copy-pair described in the resume copy request, which is recorded in the journal valid period management table 322 of the management computer 300 (Step 032).

The management computer 300, which receives the request, sends the valid period information of this copy-target storage extent to the copy-source storage apparatus 100 (Step 032a).

The storage controller of storage apparatus 100, which executes the data copy program 133, receives the valid period information, and computes the journal valid period time in the storage apparatus 200 side of the pertinent copy-pair from the time at which the resume copy request was received for each copy-pair (Step 033). For example, the journal valid period in the copy-target storage extent of the pertinent copy-pair shown in the received valid period information is 10 hours, and when the reception time of the copy recovery request is 20:00, the valid period time of the secondary journal is 10:00. Furthermore, the journal valid period time is configured for each copy-pair.

The storage controller 160 extracts a journal, for which the transfer status is “Not Transferred” from among the journals recorded in the journal information management table 137. Next, the storage controller 160 specifies from the pair configuration management table the copy-target storage extent of the data storage extent identified by the data storage extent identifier 1372 of the respective journal management information from among this extracted journal management information. Then, the storage controller compares the journal acquisition time against the journal valid period time of the specified copy-target storage extent (Step 034). When the result of Step 034 is non-transferred journals acquired at a point in time prior to the journal valid period time of the copy-target storage extent (Step 034: YES), the storage controller 160 selects, from among the non-transferred journals for which the valid period time has elapsed, the most recent journal of the journals corresponding to the write to the same address for each address inside the data storage extent 120, and sends this most recent journal to storage apparatus 200 (Step 035). The journal transfer can be the same procedure as the process described above for Steps 013 through 014c.

Conversely, when the result of Step 034 is non-transferred journals acquired subsequent to the valid period time of the copy-target storage extent, the storage controller 160 transfers journals acquired subsequent to the valid period time in write order number sequence (Step 036). When copying is complete, the storage controller 160 updates the “Transfer Status” of the journals transferred in Steps 035 and 036 to “Transferred” in the journal information management table 137 (Step 037).

Furthermore, when the most recent journal is selected and transferred from among the journals corresponding to the write to the same address in Step 035, the storage controller 160 updates the journal information management table by changing the “Transfer Status” of the journals corresponding to the write to the same address other than the latest journal from the status of “Not Transferred” to either “Transferred” or “Transfer Unnecessary”. Finally, the storage controller 160 updates the “Copy Status” of the pertinent copy-pair in the copy status management table 135 to “Normal” (Step 038). This ends the copy resume process, and processing transitions to the status of Step 001 in FIG. 11.

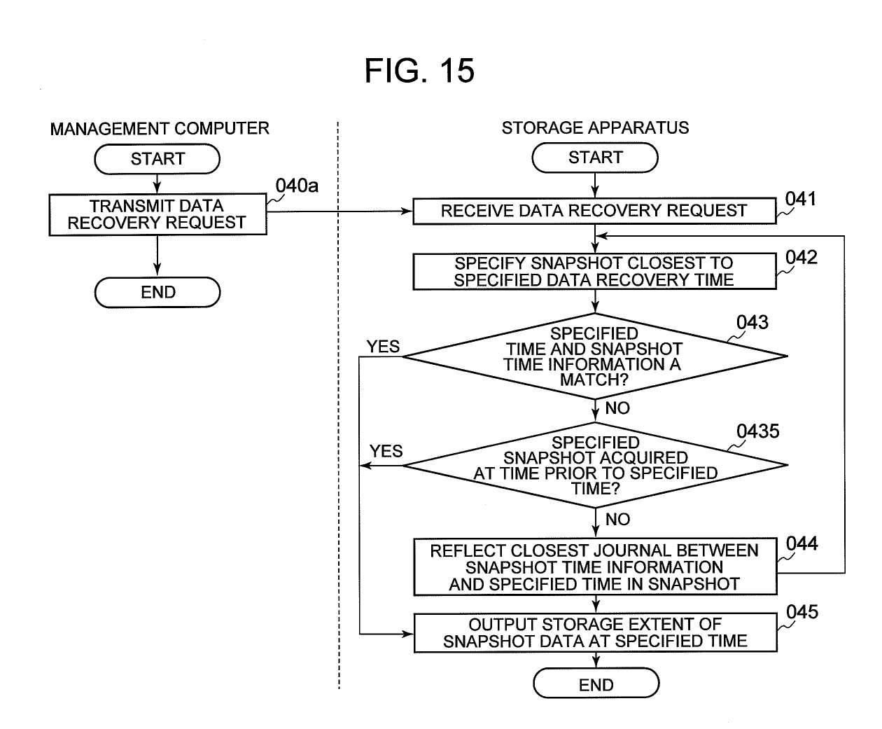

FIG. 15 shows the flow of data recovery processing by the data recovery program 134 executed by the storage controller 160 of either storage apparatus 100 or storage apparatus 200. The administrator operates the input device, and inputs the recovery-target data storage extent and the recovery time. The management computer 300, upon receiving the recovery-target data storage extent and the recovery time input, sends a data recovery request message comprising the recovery-target data storage extent and the recovery time to either storage apparatus 100 or storage apparatus 200 (Step 040a). The data recovery request message discloses at least the identifier of the storage extent showing the data recovery target storage extent, and the specified data recovery time.

The storage controller 160 receives the data recovery request, reads out the data recovery program 138, and starts execution (Step 041). The storage controller 160, which executes the data recovery program 138, references the snapshot management table 139, and extracts the snapshots, which coincide with the data storage extent identifier 1392 in the recovery-target storage extent. The storage controller 160 also specifies the snapshot, or these snapshots, which either coincides with the specified recovery time, or which was acquired at the most recent point in time of the snapshots of prior to the specified time (Step 042).

When the specified recovery time and the snapshot acquisition time coincide in the result of Step 042 (Step 043: YES), the storage controller 160 transmits this snapshot storage extent identifier 1391 to the management information input/output program 131 (Step 045).

Conversely, when the specified recovery time and snapshot acquisition time do not coincide (Step 043: NO), the storage controller 160 compares the specified recovery time and snapshot acquisition time, and determines if the snapshot acquisition time is subsequent to the specified recovery time (Step 0435). When the determination result is that the snapshot acquisition time is subsequent to the specified recovery time (Step 0435: YES), the storage controller 160 transmits the storage extent identifier 1391 for this snapshot to the management information input/output program 131 (Step 045).

Conversely, when the determination result of Step 0435 is NO, the storage controller reflects a journal prepared at a time closest to the snapshot acquisition time in the time-line between the snapshot acquisition time and the specified data recovery time in the snapshot (Step 044). The data write time of the reflected journal becomes the post-update acquisition time of the pertinent snapshot.

When the snapshot acquisition time subsequent to journal reflection coincides with the specified recovery time or the snapshot acquisition time is subsequent to the specified recovery time (Step 043 or Step 0435: YES), the storage controller 160 executes the management information input/output program 131, and recovers data using the address information of the snapshot subsequent to journal reflection (Step 045). As described above, the storage controller 160 recovers data by repeating the series of operations until the snapshot acquisition time coincides or is subsequent to the specified data recovery time.

Furthermore, in this embodiment, an execution procedure, which reflects in sequence new journal data in a snapshot that is older than the specified recovery time, is given as an example, but, by contrast, the procedure can be such that the oldest snapshot subsequent to the specified recovery time is acquired in Step 042, and journals of prior to the snapshot acquisition time are reflected in reverse sequence to the write order number until this snapshot acquisition time either coincides with or is prior to the specified recovery time.

Further, the storage controller 160 prepares a replication of the snapshot acquired at a point in time closest to the specified data recovery time in either the data storage extent 120 or another storage extent, and carries out the series of data recovery processes for this replicated snapshot.

Furthermore, the management computer 300 outputs journal valid period information and a range of data recoverable times related to the data storage extent 120 to the output device 330 to notify the administrator.

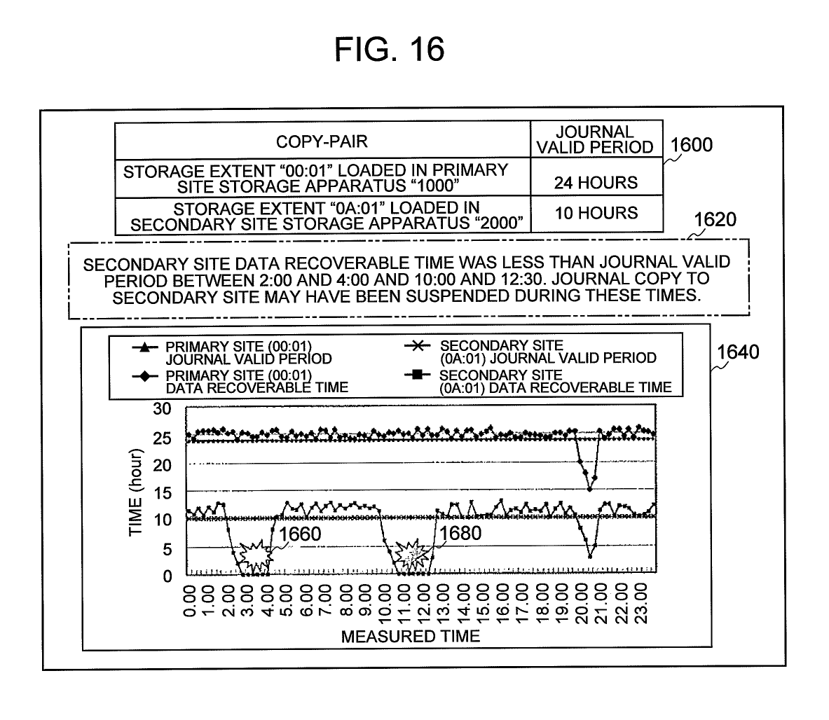

FIG. 16 shows an example of an output screen of the management computer 300.

The CPU 360 of the management computer 300, upon receiving a copy-pair specification, references the journal valid period management table 322, acquires the journal valid period 3221 of the primary site and the journal valid period 3222 of the secondary site, which are associated with the corresponding copy-pair identifier 3220, and outputs each to a display area 1600. Next, the CPU 360 regularly acquires journal information management tables from storage apparatuses 100 and 200, and computes the recoverable times for each site from the journal acquisition times of the acquired journal information management tables associated with the data storage extents corresponding to the specified copy-pair.

The CPU 360 retains the computed result, and outputs records of journal-based data recoverable times as time-lines to a display area 1640 for the primary site copy-source storage extent and secondary site copy-target storage extent, respectively.

The output example is as shown in FIG. 16, and records of journal valid period configuration values and journal-based data recoverable times are respectively outputted as time-lines to display area 1640 for the primary site copy-source storage extent and secondary site copy-target storage extent, which constitute a certain copy-pair.

Further, the management computer 300 regularly monitors the recoverable times of the respective sites, and can output a message like that of display area 1620 when the value of a computer recoverable time is less than the journal valid period for a fixed period of time. Further, in addition to this message, the management computer 300 can also highlight the corresponding portions of display area 1640 like 1660 and 1680.

Outputting the operating results like this makes it possible to analyze and determine (1) whether or not an actual journal is stored so as to achieve the same value as the configuration value of the journal valid period, and (2) whether or not the data recoverable time of the copy-target storage extent has been shortened as a result of a copy suspend. By outputting the journal status to the administrator, the management computer 300 assists in such management activities as studying future system construction and design changes.

In accordance with the above, copy control corresponding to the retention periods of journals in both a storage apparatus and storage extent can be carried out even when copy processing between storage apparatuses has been suspended.

An example of an operation of this embodiment will be explained hereinbelow.

A copy-pair, which is the copy-pair identifier 01 in the pair configuration management table 135 of FIG. 5, treats the data storage extent 00:01 inside the storage apparatus of storage apparatus identifier 1000 as the copy-source data storage extent, and treats the data storage extent 0A:01 inside the storage apparatus of storage apparatus identifier 2000 as the copy-target data storage extent.

As shown in the copy status management table 136 of FIG. 6, it is supposed that a data copy process for the copy-pair of the copy-pair identifier 01 has been updated to “Suspend” at time 09:30 due to a failure in the data transfer network.

Even after the data copy process of copy-pair 01 has been suspended, a write process to data storage extent 00:01 continues, and a journal (journal data and journal meta data) for the write process is acquired and stored by the journal acquisition program 132.

After the administrator eliminates the cause of the failure, the management computer 300 sends a resume copy request for resuming copying at time 20:00 to storage apparatus 100. Furthermore, the configuration for resuming copying and the specification of the time for resuming copying can also be inputted from the input device 340 by an administrator operation.

When a resume copy request is received in storage apparatus 100, the data copy program 133 implements a data copy resume process. As for the journals transferred in a data copy resume process, the data copy program 133 selects the most recent journals acquired during a time going back 10 hours, which is the journal valid period of the copy-target, from time 20:00 at which the resume copy request was transmitted, that is, prior to time 10:00, at each address inside the updated data storage extent, and transmits same. Further, journals acquired subsequent to time 10:00 are transferred to storage apparatus 200 in write order number sequence. When data copy resume processing is over, the copy status becomes “Normal”, and normal data copy processing (processing, which transfers journals acquired in each write to the data storage extent asynchronously to write processing) continues.

Next, for example, a case in which the administrator sends a request from the management computer to storage apparatus 200 for recovering copy-pair 01 data at time 19:00 subsequent to the end of data copy resume processing will be explained. The data recovery program 134 inside storage apparatus 200 references the snapshot management table 139, and specifies a snapshot acquired prior to 19:00, which is the specified data recovery time, and at a point in time closest thereto. In this example, the snapshot having snapshot time information 18:00 shown in FIG. 8 corresponds thereto. The data recovery program 134 reads out journals acquired for this snapshot after the time 18:00 from the journal data storage extent 121 and the journal meta data storage extent 122, and writes these journals to this snapshot by referring to the information contained in the journal meta data. More specifically, the data at time 19:00 is recovered by writing the journal denoted by write number 05 in the journal information management table shown in FIG. 7.

The preceding is an example of an operation in this embodiment.

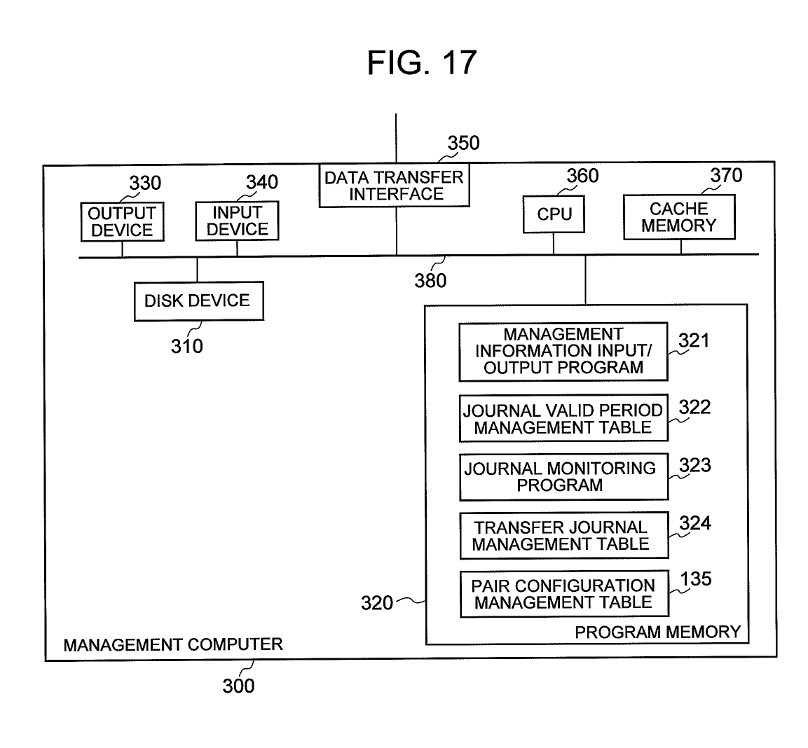

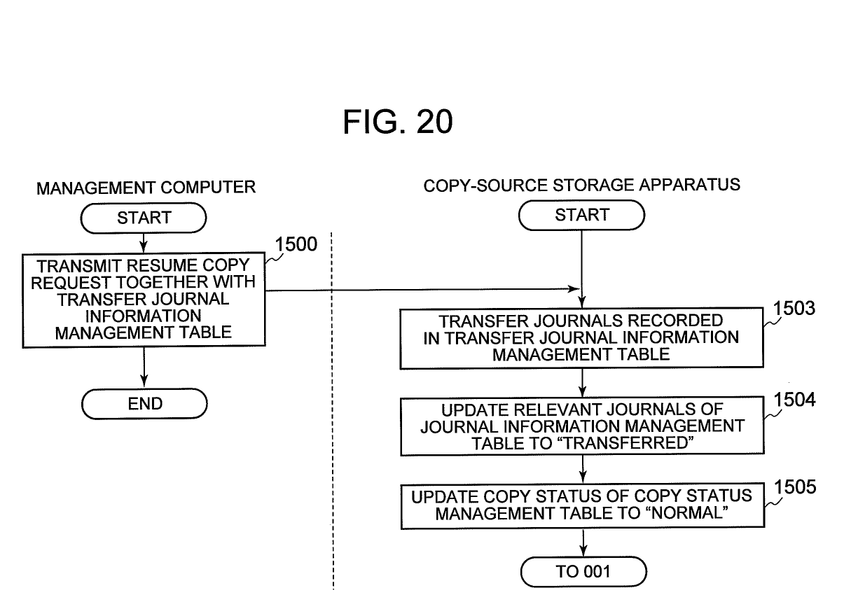

Next, a modification of the first embodiment will be explained using FIGS. 17, 18, 19 and 20. The point that differs from the first embodiment is that the processing when a data copy resumes shown in FIG. 14 is replaced by the data copy resume process of FIG. 20, which will be explained below. The configuration and connection modes of the storage system in this modification can be the same as those of the first embodiment shown in FIG. 1. Further, the configurations of storage apparatus 100 and storage apparatus 200 can also be the same as those of the first embodiment shown in FIG. 2.

FIG. 17 shows a group of programs and a group of tables retained in the program memory 320 of the management computer 300. The management information input/output program 321 and the journal valid period management table 322 can be the same as those described in the first embodiment.

A transfer journal management table 324 stores journal information to be transferred to storage apparatus 200 when data copy processing resumes in storage apparatus 100. The storage controller 160 of storage apparatus 100, which executes the data copy program 133, transfers the journals described in this table when the data copy process resumes. The pair configuration management table 135 can be the same as that described in FIG. 5. In this embodiment, storage apparatus 100 inquires as to the pair configuration and pair status in order to communicate with storage apparatus 100 and update the pair configuration management table 135 as needed.

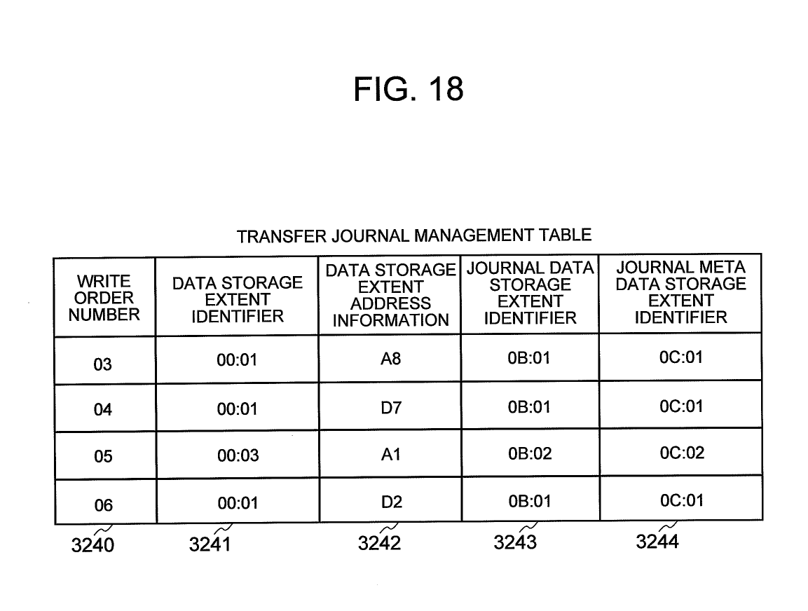

FIG. 18 shows an example of a transfer journal management table 324. In FIG. 18, the transfer journal management table 324 has at least a journal write order number 3240, data storage extent identifier 3241, data storage extent address information 3242, journal data storage extent identifier 3243, and journal meta data storage extent identifier 3244. The journal write order number 3240, data storage extent identifier 3241, data storage extent address information 3242, and journal data storage extent identifier 3243 are the same parameters as those of the journal information management table 137 previously described in FIG. 7. Furthermore, the journal meta data storage extent identifier 3244 specifies the storage extent for storing the journal information management table 137.

A journal monitoring program 322 is a program for managing a journal valid period stored in the journal storage extent inside storage apparatus 200. More specifically, the journal monitoring program 322 regularly acquires information from the journal information management table inside storage apparatus 200, and manages information related to journals transferred to storage apparatus 200 from storage apparatus 100 during a copy recovery process.

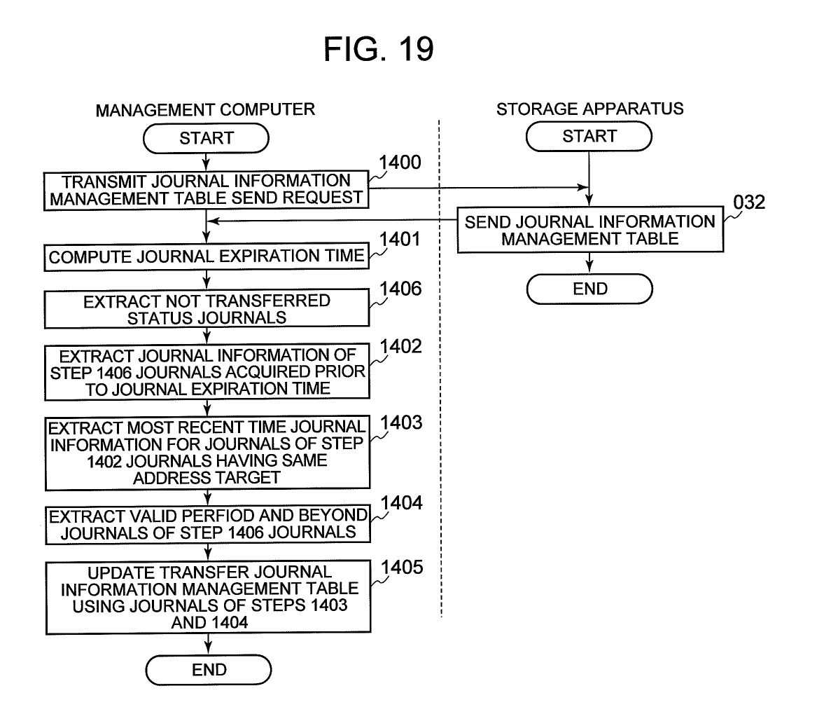

FIG. 19 shows the processing of the CPU 360 of the management computer 300, which executes the journal monitoring program 322. First, the CPU 360 requests a journal information management table from storage apparatus 100 (Step 1400). Storage apparatus 100, which received the request, sends the journal information management table to the management computer 300 (Step 032).

The CPU 360 of the management computer 300 receives the journal information management table. Next, the CPU 360 references the pair configuration management table, and specifies the copy-pair identifier 1350 and copy-target storage apparatus identifier 1353, which are associated with the data storage extent identifier 3241 of the journal information management table. Then, the CPU 360 references the journal valid period management tables 322 for the respective copy-pairs corresponding to the specified copy identifiers, and computes a journal expiration time for the secondary site from the relevant journal valid time and current time (Step 1401). For example, when the current time is 10:00, and the journal valid period is 10 hours, the journal expiration time becomes 0:00 of 10 hours prior. Furthermore, a journal expiration time is configured for each copy-pair.

Then, the CPU 360 extracts journal management information for which the transfer status 1375 is “Not Transferred” from the journal information management table 137 acquired from storage apparatus 100 (Step 1406). Next, the CPU 360 specifies from the pair configuration management table a copy-target storage extent of the data storage extent, which is identified by the data storage extent identifier 3241 of the respective journal management information, from among the journal management information extracted in Step 1406, and extracts only a journal acquired at a point in time prior to the journal expiration time of this copy-target storage extent (Step 1402). Furthermore, if, among the journal management information extracted in Step 1402, there are journals in the respective data storage extents which correspond to writes to the same addresses inside these data storage extents, the CPU 360 leaves the most recent journals, and prepares extraction results, which eliminate any journal management information other than this (Step 1403). In accordance with the above steps, extraction results, which are limited to non-transferred and most recent information, are acquired for journals of prior to the journal expiration time.

In addition, the CPU 360 extracts journal information acquired subsequent to the journal expiration time from the journal management information acquired from storage apparatus 100 (Step 1404). The CPU 360 prepares the transfer journal management table 324 shown in FIG. 18 based on the journal information specified in Steps 1403 and 1404 (Step 1405).

Furthermore, as for the timing of Step 1400, this step can be carried out subsequent to eliminating a copy-related failure, or subsequent to the end of a planned suspend in storage apparatus 200 or copy line maintenance.

FIG. 20 shows the flow of processing when data copying resumes in this modification. First, the administrator inputs a resume copy request operation via the input device of the management computer 300. The CPU 360 of the management computer 300 sends the inputted resume copy request message to the transfer journal information management table 324 and storage apparatus 100 (Step 1500).

The storage controller 160, which executes the copy program 133, transfers the respective journals recorded in the transfer journal information management table 324 to storage apparatus 200 in accordance with the write order number sequence assigned to the journals (Step 1503).

The storage controller 160, upon receiving a copy-end notification from storage apparatus 200, updates the “Transfer Status” of the transferred journals to “Transferred” in the journal information management table 137 (Step 1504). When there is an old point-in-time write to the same address inside the data storage extent of the transferred journals at this time, and the transfer status is “Not Transferred”, the storage controller 160 updates the transfer status of this journal management information to either “Transferred” or “Transfer Unnecessary”.

Next, the storage controller 160 updates the “Copy Status” of the relevant copy-pair in the copy status management table 136 to “Normal” (Step 1505), and with this, ends the copy resume process.

Furthermore, in the modification, the updated journal information management table of FIG. 7 instead of FIG. 18 may be sent to storage apparatus 100 from the management computer 300. That is, the CPU 360 can associate a flag, which shows that transfer is not necessary, with other journal management information in the “Transfer Status” 1375 of the journal information management table 137 of FIG. 7 without preparing extraction results in Step 1403, and can send the journal management information associated with this flag to storage apparatus 100.

According to the modification, the management computer can indicate copy control corresponding to journal retention periods of storage apparatus 100 and storage apparatus 200. Or, the management computer can indicate copy control corresponding to an attribute of storage apparatus 200 when resuming a copy.

What is claimed is:

1. A computer system, comprising:
a first storage system having a first storage extent, which the computer uses via a network, and a first journal storage extent for storing write data contained in a write request for updating any address of the first storage extent; and
a second storage system having a second storage extent for storing replicated data of the write data stored in the first storage extent, and a second journal storage extent,
wherein the first storage system has determination means for comparing an attribute of write data stored in the first journal storage extent, against an attribute of the second journal storage extent, and determining whether or not to send the write data to the second storage system.

2. The computer system according to claim 1, wherein the attribute of write data comprises information for specifying a time, the attribute of the second journal storage extent comprises a retention period for data stored in the second journal storage extent, and the first storage system further comprises transfer means for transferring write data from the first storage system to the second storage system, and
when the transfer of write data from the first storage system to the second storage system is commenced, the determination means compares the information specifying a time and the retention period, and the transfer means transfers write data within the retention period to the second storage system in accordance with the comparison results.

3. The computer system according to claim 2, wherein the determination means further, when the comparison results show that there are a plurality of write data for the same address, from among the write data outside the retention period, specifies write data for which the time is subsequent to the time shown by the information for specifying a time contained in the attribute of the write data, from among the plurality of write data for the same address, and
the transfer means transfers the specified write data to the second storage system.

4. The computer system according to claim 3, further comprising deletion means for deleting write data, which is outside the retention period, and which is write data other than the specified write data for the same address.

5. The computer system according to claim 4, wherein the deletion means carries out deletion in accordance with the expiration of the retention period for data stored in the first journal storage extent.

6. The computer system according to claim 2, wherein the first storage system has an attribute storage extent for storing the attribute of the write data.

7. The computer system according to claim 1, wherein the first storage system has attribute information acquisition means for acquiring attribute information showing an attribute of the second journal storage extent.

8. The computer system according to claim 2, wherein the retention period of write data stored in the second journal storage extent is shorter than the retention period of write data stored in the first journal storage extent.

9. The computer system according to claim 2, wherein the second storage system has snapshot acquisition means, which comprises a third storage extent, and which acquires a snapshot using a plurality of data outside the retention period, and stores the snapshot in association with information specifying a time contained in the attributes of the used data in the third storage extent.

10. A remote copy control method for transferring data from a first storage system having a first storage extent and a first journal storage extent, to a second storage system having a second storage extent and a second journal storage extent, comprising the steps of:
updating the first storage extent using data received from a computer;
storing the data in the first journal storage extent in association with an address to be updated in the first storage extent and a write order for the address;
sending data, from among the data stored in the first journal storage extent, which is within the retention period of the data to be stored in the second journal storage extent, to the second storage system;
storing the sent data in the second journal storage extent; and
updating the second storage extent using data stored in the second journal storage extent.

11. The remote copy control method according to claim 10, further comprising the step of sending, from among the data stored in the first journal storage extent, any one data outside the retention period for the each address to the second storage system.

12. The remote copy control method according to claim 11, wherein the any one data outside the retention period, from among the data outside the retention period stored in the first journal storage extent, is data for which the write order is the most recent for the each address.

13. The remote copy control method according to claim 10, further comprising the step of determining whether or not the data stored in the first journal storage extent is within the retention period of the data stored in the second journal storage extent, when resuming a data transfer process from the first storage system to the second storage system.

14. A storage system, comprising:
a network interface connected to a computer and another storage system via a network;
a controller connected to the network; and
a plurality of disk devices connected to the controller,
wherein any one or more of the disk devices constitutes at least one of a first storage extent used by the computer, and a second storage extent for storing write data for the first storage extent received from the computer, and
the controller determines whether or not the write data is sent to the other storage system via the network interface based on a prescribed time associated with the each write data, and the retention period of the write data in the other storage system.

15. The storage system according to claim 14, wherein the retention period for retaining data for the each write data in the other storage system is contained in an attribute of a third storage extent of the other storage system in which data is stored for the each write data, and
the controller acquires the attribute of the third storage extent.
